(19) United States
(12) Patent Application Publication
(10) Pub. No.: US 2026/0299238 A1
(43) Pub. Date: Oct. 1, 2026

(54) COLLAPSE RESISTANT COUPLED ELECTRO-OPTICS SLICKLINE CABLE

(71) Applicant: Schlumberger Technology Corporation, Sugar Land, TX (US)

(72) Inventors: Joseph Varkey, Sugar Land, TX (US); David Kim, Sugar Land, TX (US); Muhammad Usman, Sugar Land, TX (US); Sheng Chang, Sugar Land, TX (US); Antonio Mauricio Cevallos Navarrete, Sugar Land, TX (US); Tam Tran, Sugar Land, TX (US)

(21) Appl. No.: 19/095,740

(22) Filed: Mar. 31, 2025

(51) Int. Cl. G02B 6/44; H01B 7/04; H01B 7/22

(52) U.S. Cl. CPC G02B 6/4432; H01B 7/046; H01B 7/22

(57) ABSTRACT

Aspects of the present disclosure provide for a cable. The cable includes a fiber bundle including a plurality of optical fibers, a first layer in contact with an outer surface of the fiber bundle, a second layer in contact with an outer diameter of the first layer, a polymeric jacket extruded over an outer diameter of the second layer, a strengthening layer disposed about the polymeric jacket, and a metallic tubular disposed about the strengthening layer.

### BACKGROUND

The present disclosure relates generally to the field of cables for use in the Oil & Gas industry. Some cables are used to transmit power to and between equipment. Some cables are used to manipulate equipment and transmit information between equipment. Cables that transmit information, such as fiber optic cables often experience optical loss due to a lack of coupling between the fibers and the other layers of the cable. Cables can also experience high loading, such as compressive loading, that may damage the cables thus hindering the efficacy of the cables. Thus, there is a need in the art for improvements to cables for accommodating high loading and separation forces while also providing accurate optical measurement and power transmission.

Aspects of the present disclosure provide for a cable. The cable includes a fiber bundle including a plurality of optical fibers, a first layer in contact with an outer surface of the fiber bundle, a second layer in contact with an outer diameter of the first layer, a polymeric jacket extruded over an outer diameter of the second layer, a strengthening layer disposed about the polymeric jacket, and a metallic tubular disposed about the strengthening layer.

### BRIEF DESCRIPTION OF DRAWINGS

So that the manner in which the above-recited features of the disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 illustrates a schematic view of an exemplary wellsite, according to one or more embodiments.

FIG. 2 illustrates a cross-section of an exemplary cable, according to one or more embodiments.

FIG. 3A illustrates a cross-section of another exemplary cable, according to one or more embodiments.

FIG. 3B illustrates a cross-section of another exemplary cable, according to one or more embodiments.

FIG. 3C illustrates a cross-section of another exemplary cable, according to one or more embodiments.

FIG. 3D illustrates a cross-section of another exemplary cable, according to one or more embodiments.

FIG. 3E illustrates a cross-section of another exemplary cable, according to one or more embodiments.

FIG. 4A illustrates a cross-section of another exemplary cable, according to one or more embodiments.

FIG. 4B illustrates a cross-section of another exemplary cable, according to one or more embodiments.

FIG. 4C illustrates a cross-section of another exemplary cable, according to one or more embodiments.

FIG. 4D illustrates a cross-section of another exemplary cable, according to one or more embodiments.

FIG. 4E illustrates a cross-section of another exemplary cable, according to one or more embodiments.

FIG. 5A illustrates a cross-section of another exemplary cable, according to one or more embodiments.

FIG. 5B illustrates a cross-section of another exemplary cable, according to one or more embodiments.

FIG. 5C illustrates a cross-section of another exemplary cable, according to one or more embodiments.

FIG. 5D illustrates a cross-section of another exemplary cable, according to one or more embodiments.

FIG. 5E illustrates a cross-section of another exemplary cable, according to one or more embodiments.

FIG. 6A illustrates a cross-section of another exemplary cable, according to one or more embodiments.

FIG. 6B illustrates a cross-section of another exemplary cable, according to one or more embodiments.

FIG. 6C illustrates a cross-section of another exemplary cable, according to one or more embodiments.

FIG. 6D illustrates a cross-section of another exemplary cable, according to one or more embodiments.

FIG. 6E illustrates a cross-section of another exemplary cable, according to one or more embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

The disclosure contemplates that terms such as “couples,” “coupling,” “couple,” and “coupled” may include but are not limited to welding, interference fitting, and/or fastening such as by using bolts, threaded connections, pins, clips, and/or screws. The disclosure contemplates that terms such as “couples,” “coupling,” “couple,” and “coupled” may include but are not limited to integrally forming. The disclosure contemplates that terms such as “couples,” “coupling,” “couple,” and “coupled” may include but are not limited to direct coupling and/or indirect coupling, such as indirect coupling through components such as links. The disclosure contemplates that terms such as “couples,” “coupling,” “couple,” and “coupled” may include, but is not limited to, intimate contact in which applied external forces (e.g., vibration, strain, compression, pressure) will be experienced by all of the coupled components.

For the sake of brevity, all similar components have been given similar reference numbers with the same last two digits and a full description of such similar components may not be repeated herein. Similarly, for the sake of brevity, all like components or layers have been given the same reference numbers, and a full description of such components may not be repeated herein.

The present disclosure generally relates to a fiber optics cable that may provide both power transmission and accurate optical measurement while also being collapse resistant. In one or more embodiments, the cable includes a cable bundle including optical fibers, a first layer in contact with the outer surface of the fiber bundle, a second layer in contact with the outer diameter of the first layer, a polymeric jacket extruded over an outer diameter of the second layer, a strengthening layer disposed about the polymeric jacket, and a metallic tubular disposed about the strengthening layer.

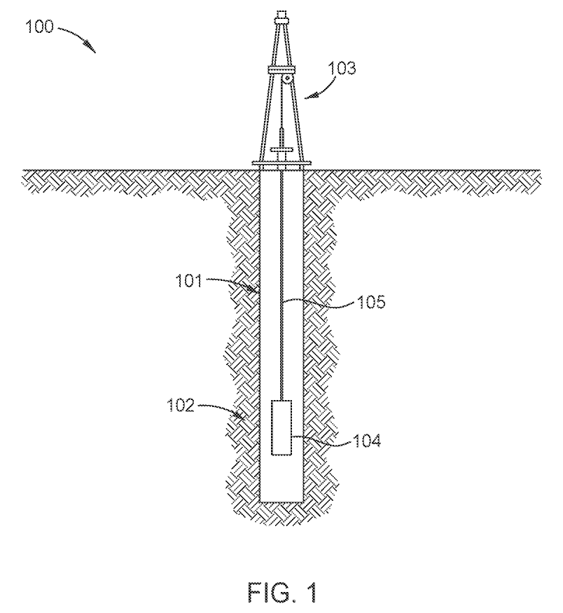

FIG. 1 illustrates a schematic view of an exemplary wellsite 100. The wellsite 100 includes a wellbore 101 drilled through a subsurface geological formation 102. At the surface, the wellsite 100 includes surface equipment 103. The surface equipment 103 may be used to lower a tool 104 down into the wellbore 101 and through the subsurface geological formation 102. A cable 105 connects downhole equipment, such as tool 104, and other equipment, such as surface equipment 103. The cable 105 may be used to transmit both information and electrical power. For example, the cable 105 may be an optical cable thus transmitting information through fiber optics. The cable 105 may also transmit power between the surface equipment 103 and the tool 104. In one or more embodiments, the cable 105 may also be used to lower the downhole equipment, such as tool 104, into the wellbore 101. In one or more embodiments, the cable may be permanent or semi-permanent in the wellbore 101 and may be installed before or after the downhole equipment is installed.

Although illustrated as being deployed in the wellbore 101, it is contemplated that the cable 105 may be disposed in coiled tubing or permanent monitoring applications in industries such as the energy, telecom, marine, geothermal, and oil & gas industries.

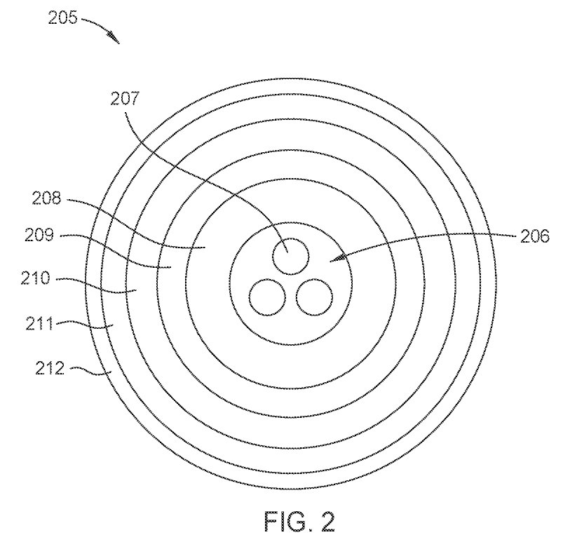

FIG. 2 illustrates a cross-section of an exemplary cable 205. The cable 205 includes a fiber bundle 206, a first layer 208, a second layer 209, a third layer 210, a fourth layer 211, and a fifth layer 212. In one or more embodiments, the cable 205 may transmit information through fiber optics. In one or more embodiments, the cable 205 may transmit power. In one or more embodiments, the cable 205 may be a slickline cable. In one or more embodiments, the cable may have an outer diameter of about 0.5 inches or less, such as 0.2 inches or less.

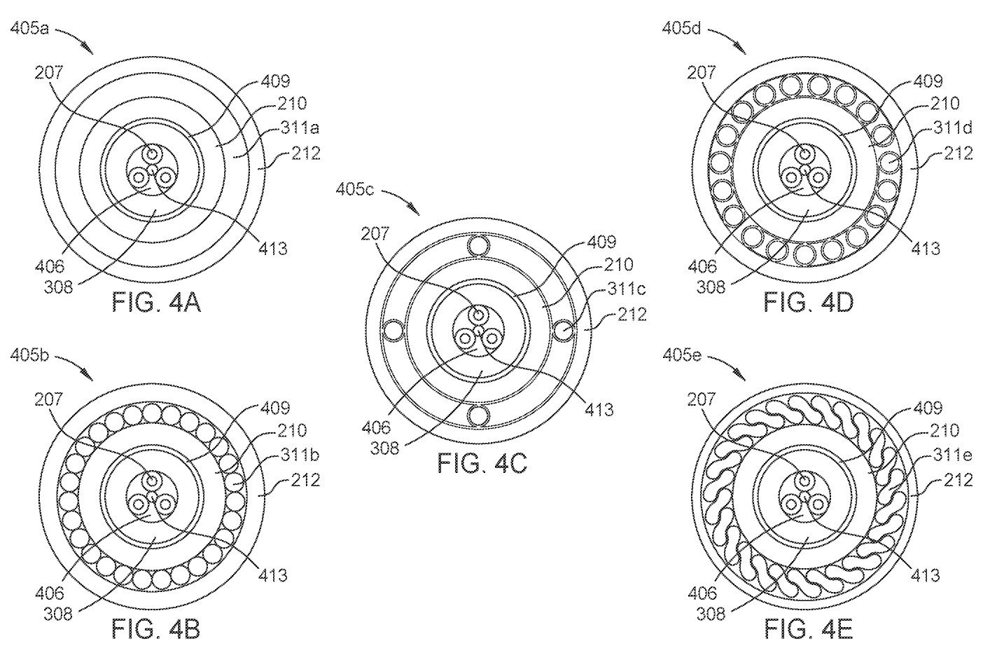

The fiber bundle 206 includes individual fibers 207. The fibers 207 may be optical fibers 207. The fibers 207 may be used to transmit information. For example, the fibers 207 may be used to transmit information between (such as between tool 104 of FIG. 1 and surface equipment 103 of FIG. 1). In one or more embodiments, the bundle 206 is closely packed such that the fibers 207 are in contact with one another so that they are radially fixed. In one or more embodiments, the fiber bundle 206 includes a core (as shown and described in FIGS. 4A-6E) that may be compressible.

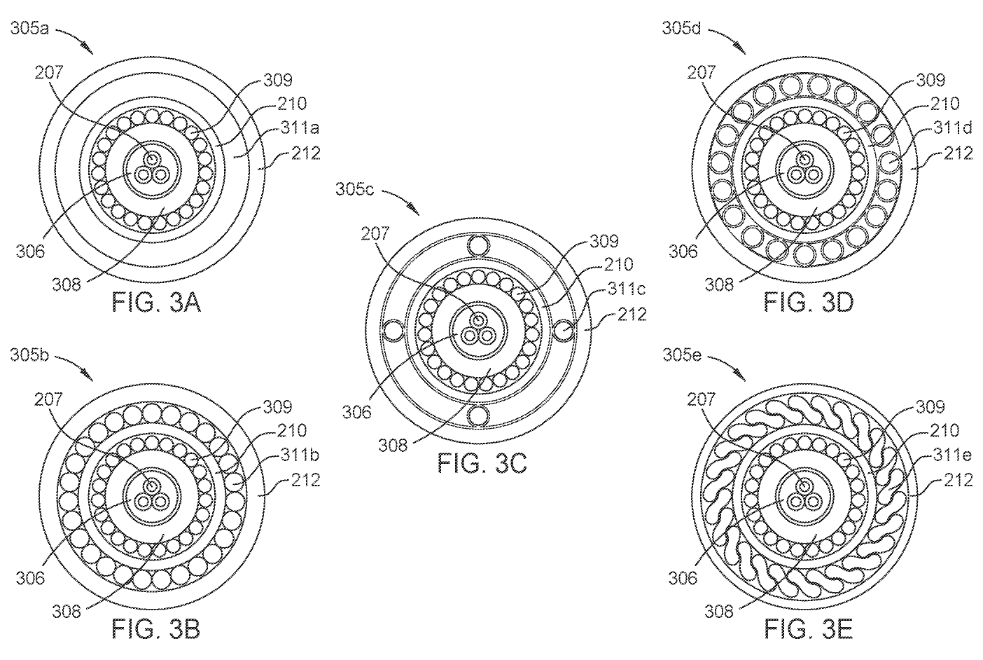

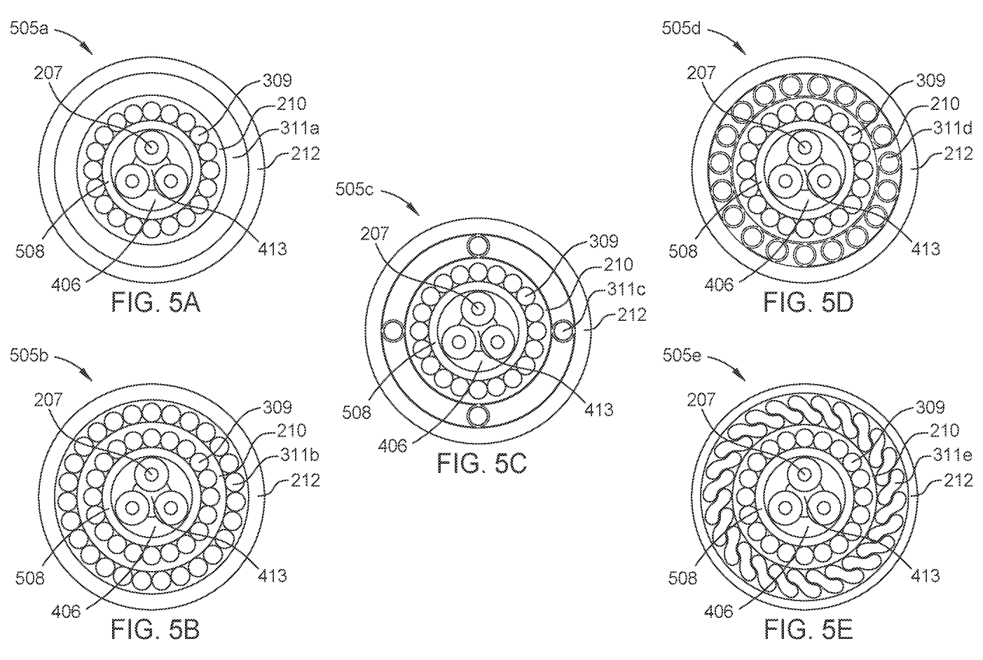

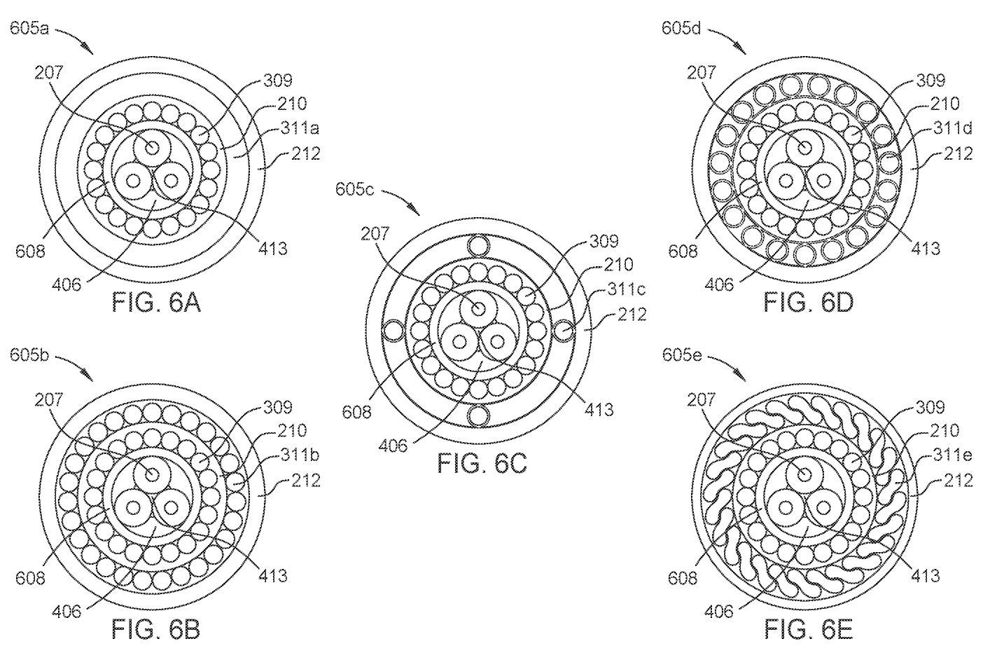

The first layer 208 is in contact with, or disposed over, the outer surface or outer diameter of the fiber bundle 206. In one or more embodiments, the first layer 208 is shaped such that the tolerance between the outer surface or outer diameter of the fiber bundle 206 and the first layer 208 is less than 1.5 mm. In one or more embodiments, the first layer 208 is in contact with the outer surface or outer diameter of the fiber bundle 206 such that there is no tolerance. The first layer 208 may include a shaped metal wire (as shown and described in FIGS. 3A-4E), a coating (as shown and described in FIGS. 5A-5E), or a tubular (as shown and described in FIGS. 6A-6E). The first layer 208 prevents optical loss by minimizing noise in measurements by the fibers 207 because signals can be better transmitted through the first layer 208 to the fibers 207 through physical contact or minimized free-space. Similarly, the contact or close proximity of the first layer 208 to the fiber bundle 206 allows for better depth control because the first layer 208 and fiber bundle 206 axially stretch together. In one or more embodiments, the first layer 208 may transmit power along the length of the cable 205. In one or more embodiments, the first layer 208 prevents the fiber bundle 206 and individual fibers 207 from moving radially. The first layer 208 may also protect the fiber bundle 206 from external forces and from subsequent layers.

The second layer 209 is in contact with, or disposed over, the outer surface or outer diameter of the first layer 208. In one or more embodiments, the tolerance between the outer surface or outer diameter of the first layer 208 and the second layer 209 is less than 1.5 mm. In one or more embodiments, the second layer 209 is in contact with the outer surface or outer diameter of the first layer 208 such that there is no tolerance. The second layer 209 may include served wire (as shown and described in FIGS. 3A-3E and 5A-6E), or may be an adhesive, such as a tape, (as shown and described in FIGS. 4A-4E). The second layer 209 prevents optical loss by minimizing noise in measurements by the fibers 207 because signals can be better transmitted through the second layer 209 and the first layer 208 to the fibers 207 through physical contact or minimized free-space. Similarly, the contact or close proximity of the second layer 209 to the first layer 208 to the fiber bundle 206 allows for better depth control because the second layer 209, the first layer 208, and fiber bundle 206 axially stretch together. In one or more embodiments, the second layer 209 holds the first layer 208 together. The second layer 209 also shields the first layer 208 and the fiber bundle 206 from external forces. In one or more embodiments, the second layer 209 also transmits power along the length of the cable between the downhole equipment and surface equipment.

The third layer 210 is in contact with, or disposed over, the outer surface or outer diameter of the second layer 209. In one or more embodiments, the tolerance between the outer surface or outer diameter of the second layer 209 and the third layer 210 is less than 1.5 mm. In one or more embodiments, the third layer 210 is in contact with the outer surface or outer diameter of the second layer 209 such that there is no tolerance. The third layer 210 may be a polymeric jacket 210. The polymeric jacket 210 is extruded over the second layer 209. The third layer 210 prevents optical loss by minimizing noise in measurements by the fibers 207 because signals can be better transmitted through the third layer 210, the second layer 209, and the first layer 208 to the fibers 207 through physical contact or minimized free-space. Similarly, the contact or close proximity of the third layer 210 to the second layer 209 to the first layer 208 to the fiber bundle 206 allows for better depth control because the third layer 210, the second layer 209, the first layer 208, and fiber bundle 206 axially stretch together. In one or more embodiments, the polymeric jacket 210 insulates the electro-optic transmission of the bundle 206, the first layer 208 and the second layer 209 from the subsequent layers of the cable 205. In one or more embodiments, the polymeric jacket 210 acts as a cushion for the bundle 206, the first layer 208, and the second layer 209.

The fourth layer 211 is in contact with, or disposed over, the outer surface or outer diameter of the third layer 210. In one or more embodiments, the tolerance between the outer surface or outer diameter of the third layer 210 and the fourth layer 211 is less than 1.5 mm. In one or more embodiments, the fourth layer 211 is in contact with the outer surface or diameter of the third layer 210 such that there is no tolerance. The fourth layer 211 may include pultruded carbon and/or synthetic fiber (as shown and described in FIGS. 3A, 4A, 5A, and 6A,) or armor wires (as shown and described in FIGS. 3B-3E, 4B-4E, 5B-5E, and 6B-6E,) . In one or more embodiments, the armor wires are served (as shown and described in FIGS. 3B, 4B, 5B, and 6B,). In one or more embodiments, the armor wires are interlocking wires (as shown and described in FIGS. 3C-3E, 4C-4E, 5C-5E, and 6C-6E,).

The fourth layer 211 is a strengthening layer. In one or more embodiments, the fourth layer 211 is compression resistant layer. The fourth layer 211 protects the third layer 210, second layer, 209, first layer 208, and fiber bundle 206 from external loading. In one or more embodiments, the fourth layer 211 protects the third layer 210, second layer, 209, first layer 208, and fiber bundle 206 from compressive forces, such as external forces, that may be imposed on the cable 205 during use. For instance, the fourth layer 211 protects the third layer 210, second layer 209, first layer 208, and the fiber bundle 206 from high pressure, bending strain, and stretching. In one or more embodiments, the fourth layer 211 prevents fatigue of the fifth layer 212. In one or more embodiments, the fourth layer 211 prevents yielding and cracking in the fifth layer 212 by supporting the fifth layer 212 from yielding and cracking when the cable 205 runs over sheaves.

In one or more embodiments, the fourth layer 211 prevents optical loss by minimizing noise in measurements by the fibers 207 because signals can be better transmitted through the fourth layer 211, the third layer 210, the second layer 209, and the first layer 208 to the fibers 207 through physical contact or minimized free-space. Similarly, the contact or close proximity of the fourth layer 211 to the third layer 210 to the second layer 209 to the first layer 208 to the fiber bundle 206 allows for better depth control because the fourth layer 211, the third layer 210, the second layer 209, the first layer 208, and fiber bundle 206 axially stretch together.

The fifth layer 212 is in contact with, or disposed over, the outer surface or outer diameter of the fourth layer 211. In one or more embodiments, the tolerance between the outer surface of the fourth layer 211 and the fifth layer 212 is less than 1.5 mm. In one or more embodiments, the fifth layer 212 is in contact with the outer surface or diameter of the fourth layer 211 such that there is no tolerance. The fifth layer 212 may be a cladding or a tubular. In one or more embodiments, the fifth layer 212 is metallic. In one or more embodiments, the fifth layer 212 is made of stainless steel or Inconel, such as Inconel 625 or 825. In one or more embodiments, the fifth layer 212 is corrosion resistant. In one or more embodiments, the fifth layer 212 is welded and drawn down around the fourth layer 211.

In one or more embodiments, the fifth layer 212 prevents optical loss by minimizing noise in measurements by the fibers 207 because signals can be better transmitted through the fifth layer 212, the fourth layer 211, the third layer 210, the second layer 209, and the first layer 208 to the fibers 207 through physical contact or minimized free-space.

FIGS. 3A-3E illustrate schematic cross-sections of exemplary cables 305a, 305b, 305c, 305d, and 305e, respectively. Exemplary cables 305a-305e each include a fiber bundle 306, a first layer 308, a second layer 309, the third layer 210, a fourth layer 311, and the fifth layer 212. Exemplary cables 305a-305e include the same components as one another except for the fourth layers 311a, 311b, 311c, 311d, and 311e which vary.

Fiber bundle 306 includes fibers 207. In one or more embodiments, the fibers 207 are in contact with or coupled to one another in the fiber bundle 306. In one or more embodiments, the outer diameter of each fiber 207 is in contact with or coupled to the outer diameter of another fiber 207. In one or more embodiments, the fibers 207 are coupled to one another so that they are radially fixed relative to one another. Interstices of each fiber can be not filled or filled with low modulus material like silicon.

The first layer 308 includes a shaped wire 308 that is disposed about, and/or in contact with, the fiber bundle 306. The shaped wire 308 is shaped complementary to the outer diameter of the fiber bundle 306. The shaped wire 308 is dimensioned such that only a small tolerance exists, if any tolerance exists, between the shaped wire 308 and the fiber bundle 306.

The shaped wire 308 conducts power along the cables 305a-305e thus allowing the cables 305a-305e to transmit both power and information. Accordingly, the shaped wire 308 is conductive (i.e. has a low electrical resistance).

The second layer 309 includes served wires 309. The served wires 309 may be metal wires 309. The served wires 309 are wrapped around the shaped wire 308 such that they lay on the shaped wire 308. The served wires 309 may have any lay angle, such as an angle between 0 degrees and 360 degrees. In one or more embodiments, the served wires 309 hold the shaped wire 308 together and prevent radial movement of the fiber bundle 306 and the shaped wire 308.

In one or more embodiments, the served wires 309 conduct power along the cables 305a-305e thus allowing the cables 305a-305e to transmit both power and information. Accordingly, the served wires 309 are conductive (i.e. low electrical resistance).

The third layer 210 is disposed about the served wires 309 and includes a polymeric jacket 210 as described above in FIG. 2. The fourth layer 311 is disposed about and/or is in contact with the polymeric jacket 210. The composition of the fourth layer 311 varies among cables 305a-305e. The fifth layer 212 is disposed about and/or is in contact with the fourth layer 311 and includes a tubular 212 and/or cladding as shown and described in FIG. 2

FIG. 3A illustrates a cross-section of cable 305a. Cable 305a includes the fiber bundle 306 including fibers 207, the shaped wire 308, the served wires 309, the polymeric jacket 210, a carbon or synthetic fiber layer 311a as the fourth layer 311, and the tubular 212.

The fourth layer 311 is a carbon or synthetic fiber layer 311a. The carbon fiber layer 311a is pultruded over the polymer jacket 210, the served wires 309, the shaped wire 308, and the fiber bundle 306. As previously mentioned with respect to fourth layer 311, the carbon fiber layer 311a is a strengthening layer that protects the fiber bundle 306 from external loads and prevents fatigue of the tubular 212.

FIGS. 3B-3E illustrate cross-sections of cables 305b-305e, respectively. Cables 305b-305e include the fiber bundle 306 including fibers 207, the shaped wire 308, the served wires 309, the polymeric jacket 210, an armor wire layer 311b-311e as the fourth layer 311, and the tubular 212.

FIG. 3B illustrates a cable 305b including an armor wire layer 311b as the fourth layer 311. The armor wires of the armor wire layer 311b are laid around the polymer jacket 210. The armor wires of the armor wire layer 311b may be laid at any lay angle, such as an angle between 0 degrees and 360 degrees. As previously mentioned with respect to fourth layer 311, the armor wire layer 311b is a strengthening layer that protects the fiber bundle 306 from external loads and prevents fatigue of the tubular 212.

FIGS. 3C-3E illustrate cross-sections of cables 305c-305e, respectively. Cables 305c-305e include an interlocking armor wire layer 311c-311e as the fourth layer 311. The interlocking armor wires of the interlocking armor wire layer 311c-311e are laid over the polymer jacket 210. The interlocking armor wires of the interlocking armor wire layer 311c-311e may be laid at any lay angle, such as an angle between 0 degrees and 360 degrees. The interlocking armor wires of the interlocking armor wire layer 311c-311e are shaped complementary to one or more adjacent interlocking armor wires so that they interlock with one another (e.g., “shaped interlocking armor wires”). As an example, FIG. 3C illustrates one embodiment of the interlocking armor wire layer 311c. As another example, FIG. 3D illustrates one embodiment of the interlocking armor wire layer 311d. As another example, FIG. 3E illustrates one embodiment of the interlocking armor wire layer 311d. The interlocking armor wires are shaped so that when they are laid over one another they interlock and do not open up (e.g., loosen).

As previously mentioned with respect to fourth layer 311, the interlocking armor wire layer 311c-311e is a strengthening layer that protects the fiber bundle 306 from external loads and prevents fatigue of the tubular 212.

FIGS. 4A-4E illustrate schematic cross-sections of exemplary cables 405a, 405b, 405c, 405d, and 405e, respectively. Exemplary cables 405a-405e each include a fiber bundle 406, the first layer 308, a second layer 409, the third layer 210, the fourth layer 311, and the fifth layer 212. Exemplary cables 405a-405e include the same components as one another except for the fourth layers 311a, 311b, 311c, 311d, and 311e which vary and have been described above with respect to FIGS. 3A-3E.

The fiber bundle 406 includes fibers 207 and a core 413. The core 413 may be a flexible or semi-flexible core that allows the fiber bundle 406 to be more flexible. In one or more embodiments, the core 413 allows the fiber bundle 406 to be axially flexible (e.g. axially stretch). In one or more embodiments, the fibers 207 are in contact with or coupled to the core 413. In one or more embodiments, the outer diameter of each fiber 207 is in contact with or coupled to the outer diameter of the core 413. In one or more embodiments the core 413 is circular. In one or more embodiments, the core 413 is not circular. In one or more embodiments, the core 413 is helically wound within the bundle 406. In one or more embodiments, the core 413 is compressed (as shown in FIGS. 5A-6E). In one or more embodiments, the core 413 is not compressed (as shown in FIGS. 4A-4E). Interstices of each fiber can be not filled or filled with low modulus material like silicon.

The first layer 308 includes a shaped wire 308 which has been previously described in FIGS. 3A-3E. The second layer 409 includes adhesive, such as a tape 409. The tape 409 is disposed over and attached to the outer surface or outer diameter of the shaped wire 308. In one or more embodiments, the tape 409 is a soft polymer material such as polyimide, peek, nylon, or any other polymer types. In one or more embodiments, the tape 409 is a metallic material such as copper, aluminum, steel, or any other metal tape types. In one or more embodiments, the tape 409 is a combination of polymer and metal. In one or more embodiments, the tape 409 is overlapped when assembled to the first layer 308. In one or more embodiments, the tape 409 is not overlapped when assembled to the first layer 308.

The third layer 210 is disposed about the tape 409 and includes a polymeric jacket 210 as described above in FIG. 2. The fourth layer 311 is disposed about and/or is in contact with the polymeric jacket 210. The composition of the fourth layer 311 varies among cables 405a-405e. The fifth layer 212 is disposed about and/or is in contact with the fourth layer 311 and includes a tubular 212 and/or cladding as shown and described in FIG. 2

FIG. 4A illustrates a cross-section of cable 405a. Cable 405a includes the fiber bundle 406 including fibers 207 and the core 413, the shaped wire 308, the tape 409, the polymeric jacket 210, a carbon fiber layer 311a as the fourth layer 311, and the tubular 212. The carbon fiber layer 311a has been previously described in FIG. 3A.

FIGS. 4B-4E illustrate cross-sections of cables 405b-405e, respectively. Cables 405b-405e include the fiber bundle 406 including fibers 207 and the core 413, shaped wire 308, the tape 409, the polymeric jacket 210, an armor wire layer 311b-311e as the fourth layer 311, and the tubular 212.

FIG. 4B illustrates the cross-section of a cable 405b including an armor wire layer 311b which has been previously described in FIG. 3B. FIGS. 4C-4E illustrate cross-sections of cables 405c-405e with an interlocking armor wire layer 311c-311ewhich has been previously described in FIGS. 3C-3E.

FIGS. 5A-5E illustrate schematic cross-sections of exemplary cables 505a, 505b, 505c, 505d, and 505e, respectively. Exemplary cables 505a-505eeach include the fiber bundle 406, a first layer 508, the second layer 309, the third layer 210, the fourth layer 311, and the fifth layer 212. Exemplary cables 505a-505e include the same components as one another except for the fourth layers 311a, 311b, 311c, 311d, and 311e which vary and have been described with respect to FIGS. 3A-3E above.

The fiber bundle 406 includes fibers 207 and a core 413 and has been described in FIGS. 4A-4E. The first layer 508 includes a coating 508. The coating 508 is disposed over and coats the fiber bundle 406. In one or more embodiments, the coating 508 is a polymer coating. In one or more embodiments, the coating 508 is of a sufficient thickness to provide cushion for the fiber bundle 406 when the cables 505a-505e experience external loading.

The second layer 309 includes served wires 309 and has been described in FIGS. 3A-3E. The third layer 210 includes a polymeric jacket 210 and has been shown and described in FIG. 2. The fourth layer 311 is disposed about and/or is in contact with the polymeric jacket 210. The composition of the fourth layer 311 varies among cables 505a-505e. The fifth layer 212 is disposed about and/or is in contact with the fourth layer 311 and includes a tubular 212 and/or cladding as shown and described in FIG. 2

FIG. 5A illustrates a cross-section of cable 505a. Cable 505a includes the fiber bundle 406 including fibers 207 and the core 413, the coating 508, the served wires 309, the polymeric jacket 210, a carbon fiber layer 311a as the fourth layer 311, and the tubular 212. The carbon fiber layer 311a has been previously described in FIG. 3A.

FIGS. 5B-5E illustrate cross-sections of cables 505b-505e, respectively. Cables 505b-505e include the fiber bundle 406 including fibers 207 and the core 413, coating 508, the served wires 309, the polymeric jacket 210, an armor wire layer 311b-311eas the fourth layer 311, and the tubular 212.

FIG. 5B illustrates the cross-section of a cable 505b including an armor wire layer 311b which has been previously described in FIG. 3B. FIGS. 5C-5E illustrate cross-sections of cables 505c-505e with an interlocking armor wire layer 311c-311e which has been previously described in FIGS. 3C-3E.

FIGS. 6A-6E illustrate schematic cross-sections of exemplary cables 605a, 605b, 605c, 605d, and 605e, respectively. Exemplary cables 605a-605e each include the fiber bundle 406, a first layer 608, the second layer 309, the third layer 210, the fourth layer 311, and the fifth layer 212. Exemplary cables 605a-605einclude the same components as one another except for the fourth layers 311a, 311b, 311c, 311d, and 311e which vary.

The fiber bundle 406 includes fibers 207 and a core 413, and has been described in FIGS. 4A-4E. The first layer 608 includes cladding or a tubular 608 in contact with, or disposed over, the outer surface or outer diameter of the fiber bundle 406. In one or more embodiments, the tubular 608 is metallic. In one or more embodiments, the tubular is welded and drawn down around the fiber bundle 406.

The second layer 309 includes served wires 309 and has been described in FIGS. 3A-3E. The third layer 210 includes a polymeric jacket 210 and has been described above in FIG. 2. The fourth layer 311 is disposed about and/or in contact with the polymeric jacket 210. The composition of the fourth layer 311 varies among cables 605a-605e. The fifth layer 212 is disposed about and/or is in contact with the fourth layer 311 and includes a tubular 212 and/or cladding as shown and described in FIG. 2

FIG. 6A illustrates a cross-section of cable 605a. Cable 605a includes the fiber bundle 406 including fibers 207 and the core 413, the tubular 608, the served wires 309, the polymeric jacket 210, a carbon fiber layer 311a as the fourth layer 311, and the tubular 212. The carbon fiber layer 311ahas been previously described in FIG. 3A.

FIGS. 6B-6E illustrate cross-sections of cables 605b-605e, respectively. Cables 605b-605e include the fiber bundle 406 including fibers 207 and the core 413, the tubular 608, the served wires 309, the polymeric jacket 210, an armor wire layer 311b-311e as the fourth layer 311, and the tubular 212.

FIG. 6B illustrates the cross-section of a cable 605b including an armor wire layer 311b which has been previously described in FIG. 3B. FIGS. 6C-6E illustrate cross-sections of cables 605c-605e with an interlocking armor wire layer 311c-311e which has been previously described in FIGS. 3C-3E.

### Example Aspects

Aspect 1: A cable including a fiber bundle including a plurality of optical fibers, a first layer in contact with an outer surface of the fiber bundle, a second layer in contact with an outer diameter of the first layer, a polymeric jacket extruded over an outer diameter of the second layer, a strengthening layer disposed about the polymeric jacket, and a metallic tubular disposed about the strengthening layer.

Aspect 2: The cable of Aspect 1, wherein the second layer comprises served metal wires configured to transmit electrical power.

Aspect 3: The cable of Aspect 1 or Aspect 2, wherein the first layer comprises a metal wire, wherein the metal wire is shaped complementary to the outer diameter of the fiber bundle such that an inner diameter of the metal wire contacts and is coupled to the outer diameter of the fiber bundle, and wherein the metal wire is configured to transmit electrical power.

Aspect 4: The cable of Aspect 1 or Aspect 3, wherein the second layer comprises served metal wires configured to transmit electrical power.

Aspect 5: The cable of any of Aspects 1-4, wherein the strengthening layer comprises a carbon fiber composite pultruded over the polymeric jacket.

Aspect 6: The cable of any of Aspects 1-4, wherein the strengthening layer comprises a plurality of armor wires disposed about the polymeric jacket.

Aspect 7: The cable of Aspect 6, wherein each armor wire of the plurality of armor wires is shaped such that each armor wire interlocks with another armor wire of the plurality of armor wires.

Aspect 8: The cable of Aspect 1 or Aspect 3, wherein the fiber bundle further comprises a core filled with silicone and disposed between and in contact with each optical fiber of the plurality of optical fibers.

Aspect 9: The cable of any of Aspects 1, 3, and 5-8, wherein the second layer comprises a tape layer.

Aspect 10: The cable of any of Aspects 1-4 and 8-9, wherein the strengthening layer comprises a carbon fiber composite pultruded over the polymeric jacket.

Aspect 11: The cable of Aspect 1-4 and 8-9, wherein the strengthening layer comprises a plurality of armor wires disposed about the polymeric jacket.

Aspect 12: The cable of Aspect 11, wherein each armor wire of the plurality of armor wires is shaped such that each armor wire interlocks with another armor wire of the plurality of armor wires.

Aspect 13: The cable of Aspect 1 or Aspect 2, wherein the fiber bundle further comprises a core filled with silicone and disposed between each optical fiber of the plurality of optical fibers.

Aspect 14: The cable of any of Aspects 1-2 and 4-13, wherein the first layer comprises a polymer coating.

Aspect 15: The cable of any of Aspects 1-4, 8-9, and 13-14, wherein the strengthening layer comprises a carbon fiber composite pultruded over the polymeric jacket.

Aspect 16: The cable of any of Aspects 1-4, 8-9, and 13-14, wherein the strengthening layer comprises a plurality of armor wires disposed about the polymeric jacket.

Aspect 17: The cable of Aspect 16, wherein each armor wire of the plurality of armor wires is shaped such that each armor wire interlocks with another armor wire of the plurality of armor wires.

Aspect 18: The cable of any of Aspects 1-2, 4-13 and 15-17, wherein the first layer comprises a metal tube.

Aspect 19: The cable of Aspect 18, wherein the strengthening layer comprises a carbon fiber composite pultruded over the polymeric jacket.

Aspect 20: The cable of Aspect 1-4, 8-9, 13-14, and 18, wherein the strengthening layer comprises a plurality of armor wires disposed about the polymeric jacket.

Aspect 21: The cable of Aspect 20, wherein each armor wire of the plurality of armor wires interlocks with another armor wire of the plurality of armor wires.

Any one or more components of cables 105, 205, 305a-305e, 405a-405e, 505a-505e, and 605a-605emay be integrally formed together, directly coupled together, and/or indirectly coupled together and are not limited to the specific arrangement of components illustrated in FIGS. 1-6E. Any one or more of the embodiments of the cables 105, 205, 305a-305e, 405a-405e, 505a-505e, and 605a-605e may be combined in whole or part with any one or more of the embodiments of the cables 105, 205, 305a-305e, 405a-405e, 505a-505e, and 605a-605e

While the present disclosure has been described with respect to a number of embodiments and examples, those skilled in the art, having benefit of this disclosure, will appreciate that other embodiments can be devised which do not depart from the scope and spirit of the present disclosure.

It will be appreciated by those skilled in the art that the preceding embodiments are exemplary and not limiting. It is intended that all modifications, permutations, enhancements, equivalents, and improvements thereto that are apparent to those skilled in the art upon a reading of the specification and a study of the drawings are included within the scope of the disclosure. It is therefore intended that the following appended claims may include all such modifications, permutations, enhancements, equivalents, and improvements. The disclosure also contemplates that one or more aspects of the embodiments described herein may be substituted in for one or more of the other aspects described. The scope of the disclosure is determined by the claims that follow.

What is claimed is:

1. A cable, comprising:
a fiber bundle comprising a plurality of optical fibers;
a first layer in contact with an outer surface of the fiber bundle;
a second layer in contact with an outer diameter of the first layer;
a polymeric jacket extruded over an outer diameter of the second layer;
a strengthening layer disposed about the polymeric jacket; and
a metallic tubular disposed about the strengthening layer.

2. The cable of claim 1, wherein the second layer comprises served metal wires configured to transmit electrical power.

3. The cable of claim 1, wherein the first layer comprises a metal wire, wherein the metal wire is shaped complementary to the outer diameter of the fiber bundle such that an inner diameter of the metal wire contacts and is coupled to the outer diameter of the fiber bundle, and wherein the metal wire is configured to transmit electrical power.

4. The cable of claim 3, wherein the second layer comprises served metal wires configured to transmit electrical power.

5. The cable of claim 4, wherein the strengthening layer comprises a carbon fiber composite pultruded over the polymeric jacket.

6. The cable of claim 4, wherein the strengthening layer comprises a plurality of armor wires disposed about the polymeric jacket.

7. The cable of claim 6, wherein each armor wire of the plurality of armor wires is shaped such that each armor wire interlocks with another armor wire of the plurality of armor wires.

8. The cable of claim 3, wherein the fiber bundle further comprises a core filled with silicone and disposed between and in contact with each optical fiber of the plurality of optical fibers.

9. The cable of claim 8, wherein the second layer comprises a tape layer.

10. The cable of claim 9, wherein the strengthening layer comprises a carbon fiber composite pultruded over the polymeric jacket.

11. The cable of claim 9, wherein the strengthening layer comprises a plurality of armor wires disposed about the polymeric jacket.

12. The cable of claim 11, wherein each armor wire of the plurality of armor wires is shaped such that each armor wire interlocks with another armor wire of the plurality of armor wires.

13. The cable of claim 2, wherein the fiber bundle further comprises a core filled with silicone and disposed between each optical fiber of the plurality of optical fibers.

14. The cable of claim 13, wherein the first layer comprises a polymer coating.

15. The cable of claim 14, wherein the strengthening layer comprises a carbon fiber composite pultruded over the polymeric jacket.

16. The cable of claim 14, wherein the strengthening layer comprises a plurality of armor wires disposed about the polymeric jacket.

17. The cable of claim 16, wherein each armor wire of the plurality of armor wires is shaped such that each armor wire interlocks with another armor wire of the plurality of armor wires.

18. The cable of claim 13, wherein the first layer comprises a metal tube.

19. The cable of claim 18, wherein the strengthening layer comprises a carbon fiber composite pultruded over the polymeric jacket.

20. The cable of claim 18, wherein the strengthening layer comprises a plurality of armor wires disposed about the polymeric jacket.

21. The cable of claim 20, wherein each armor wire of the plurality of armor wires interlocks with another armor wire of the plurality of armor wires.
